(19) United States
(12) Patent Application Publication
(10) Pub. No.: US 2007/0125405 A1
(43) Pub. Date: Jun. 7, 2007

(54) Substrate cleaning method and substrate cleaning apparatus

(75) Inventors: Kenji Sekiguchi, Nirasaki-shi (JP); Hiroki Ohno, Nirasaki-shi (JP)

Correspondence Address: SMITH, GAMBRELL & RUSSELL, 1850 M STREET, N.W., SUITE 800, WASHINGTON, DC, 20036, US

(73) Assignee: Tokyo Electron Limited

(21) Appl. No.: 11/606,159

(22) Filed: Nov. 30, 2006

(30) Foreign Application Priority Data
Dec. 2, 2005 (JP) JP 2005-349132

(51) Int. Cl. B08B 3/00; B08B 7/00

(52) U.S. Cl. 134/34; 134/33; 134/26; 134/94.1; 134/100.1; 134/103.2

(57) ABSTRACT

A substrate cleaning method, including a step of supplying a two-fluid spray made up of a liquid and a gas to the front surface of a substrate, is provided; wherein the supplying of the two-fluid spray is carried out using a mixture of purified water and isopropyl alcohol as a liquid; concentration of the isopropyl alcohol in the mixture is 10 to 60 wt %; and a particle rejection ratio is 80% or greater.

### BACKGROUND OF THE INVENTION

1. Field of the Invention

The present invention relates to a substrate cleaning method and a substrate cleaning apparatus, which are used to clean semiconductor wafers, substrates for flat panel displays (FPDs) such as glass substrates for liquid crystal displays (LCDs), and substrates for other devices.

2. Description of the Related Art

In a semiconductor device manufacturing process, a semiconductor wafer (hereafter, simply referred to as wafer) is cleaned using a predetermined chemical (cleaning liquid), and a cleaning process of removing a polymer and the like after contamination and etching processes of particles, organic contaminants, metal impurities and the like adhered to the wafer are completed is then carried out.

A sheet-fed wafer cleaning apparatus that carries out a cleaning process by holding the wafer on a spin chuck, supplying a processing liquid onto the front and back surfaces of the wafer, rinsing them if necessary, and then drying while spinning the wafer at a high speed is known as such a wafer cleaning apparatus for carrying out that cleaning process.

As for such a sheet-fed wafer cleaning apparatus, a technology using a two-fluid spray made of purified water and N₂ gas to remove particles adhered to the wafer efficiently is well-known (See Japanese Patent Application Laid-open No. Hei 8-318181, for example).

However, as miniaturization of patterns advances recently, when using a wafer with a pattern, damages such as pattern slanting are likely to occur, and damage of patterns increases when trying to sufficiently remove particles using a two-fluid spray. Furthermore, when trying to keep pattern damage below a permissible limit, particle rejection ratio becomes inadequate.

### BRIEF SUMMARY OF THE INVENTION

The present invention aims to provide a substrate cleaning method and a substrate cleaning apparatus capable of effectively rejecting particles on a substrate while keeping damage to the substrate below a permissible limit.

The present invention also aims to provide a computer readable storage media to implement such method.

According to a first aspect of the present invention, a substrate cleaning method is provided. The substrate cleaning method includes: preparing a substrate; and supplying a two-fluid spray made up of a liquid and a gas to the front surface of the substrate, wherein: the supplying of the two-fluid spray is carried out using a mixture of purified water and isopropyl alcohol as a liquid; concentration of the isopropyl alcohol in the mixture is 10 to 60 wt %; and a particle rejection ratio is 80% or greater.

According to a second aspect of the present invention, a substrate cleaning method is provided. The substrate cleaning method includes: preparing a substrate; supplying a chemical to the front surface of the substrate; supplying a two-fluid spray made up of a liquid and a gas to the front surface of the substrate after the chemical is supplied; and rinsing. The supplying of the two-fluid spray is carried out using a mixture of purified water and isopropyl alcohol as a liquid. Concentration of the isopropyl alcohol in the mixture is 10 to 60 wt %. The substrate cleaning method providing a particle rejection ratio of 80% or greater.

According to a third aspect of the present invention, a substrate cleaning method is provided. The substrate cleaning method includes: preparing a substrate; supplying a two-fluid spray made up of a liquid and a gas to the front surface of the substrate; supplying a rinsing liquid to the substrate after the two-fluid spray is supplied; and rinsing, wherein: he supplying of the two-fluid spray is carried out using a mixture of purified water and isopropyl alcohol as a liquid; concentration of the isopropyl alcohol in the mixture is 10 to 60 wt %; and a particle rejection ratio is 80% or greater.

In the above-given first through the third aspect, rotating the substrate and shaking off and drying liquid remaining on the substrate may be further included. In this case, the shaking off and drying may be carried out while supplying nearly 100% concentration of isopropyl alcohol, or while supplying nearly 100% concentration of isopropyl alcohol and nitrogen gas. Furthermore, concentration of the isopropyl alcohol in the mixture is preferably 30 to 40 wt % and the particle rejection ratio is preferably 85% or greater. Moreover, flow rate of the mixture may be 200 mL/min or greater.

According to a fourth aspect of the present invention, a substrate cleaning apparatus configured to clean the front surface of a substrate is provided. The substrate cleaning apparatus includes: a substrate holding unit, which holds the substrate horizontally; a two-fluid spray nozzle, which supplies a two-fluid spray made up of a gas and a mixture of purified water and isopropyl alcohol to the front surface of the substrate; and a control mechanism, which controls amounts of purified water, isopropyl alcohol, and the gas to be supplied from the two-fluid spray nozzle such that the isopropyl alcohol concentration within the mixture can be 10 to 60 wt % and that a particle rejection ratio for the substrate by the two-fluid spray can be 80% or greater.

According to a fifth aspect of the present invention, a computer readable storage media in which a control program to be executed by a computer is stored is provided, wherein: the control program represents a substrate cleaning method comprising preparing a substrate and supplying a two-fluid spray made up of a liquid and a gas to the front surface of the substrate, which are executed in conformity with the control program, and the control program causes the computer to control a liquid processing apparatus implementing the substrate cleaning method such that the supplying of the two-fluid spray uses as a liquid a mixture of purified water and isopropyl alcohol, which has a concentration of 10 to 60 wt % within the mixture and a particle rejection ratio of 80% or greater.

According to the present invention, use of a mixture of purified water and isopropyl alcohol as the liquid for the two-fluid spray made up of a liquid and a gas, and the concentration of the isopropyl alcohol of 10 to 60 wt % within the mixture allows effective rejection of particles on the substrate and a particle rejection ratio of 80% or greater.

### BRIEF DESCRIPTION OF THE SEVERAL VIEWS OF THE DRAWING

FIG. 1 is a top view schematically showing an exemplary cleaning apparatus used for implementing a method according to an embodiment of the present invention;

FIG. 2 is a cross section schematically showing the cleaning apparatus of FIG. 1;

FIG. 3 is a diagram showing a liquid and gas supply system of the cleaning apparatus of FIG. 1;

FIG. 4 is a flowchart describing an exemplary sequence of a wafer front surface cleaning process by the cleaning apparatus of FIG. 1;

FIGS. 5A through 5E are schematics describing each step of FIG. 4;

FIG. 6 is a graph showing a relationship between N₂ gas flow rate and particle rejection ratio, and a relationship between N₂ gas flow rate and number of pattern damages on the wafer when changing the IPA concentration of a mixture used for a two-fluid spray;

FIGS. 7A and 7B are schematics showing a case of supplying IPA and drying, and a case of supplying IPA and N₂ gas and drying, respectively;

FIG. 8 is a flowchart describing another exemplary sequence of a wafer front surface cleaning process by the cleaning apparatus of FIG. 1; and

FIG. 9 is a flowchart describing yet another exemplary sequence of a wafer front surface cleaning process by the cleaning apparatus of FIG. 1.

### DETAILED DESCRIPTION OF THE INVENTION

An embodiment of the present invention is described in detail forthwith while referencing the appended drawings. A case of applying the present invention to a wafer cleaning apparatus capable of cleaning the front and back surfaces of a wafer simultaneously is described now.

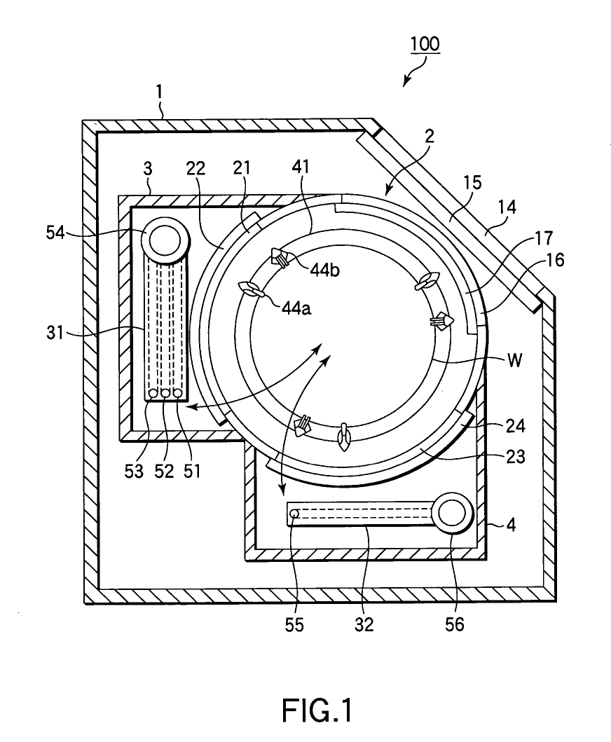

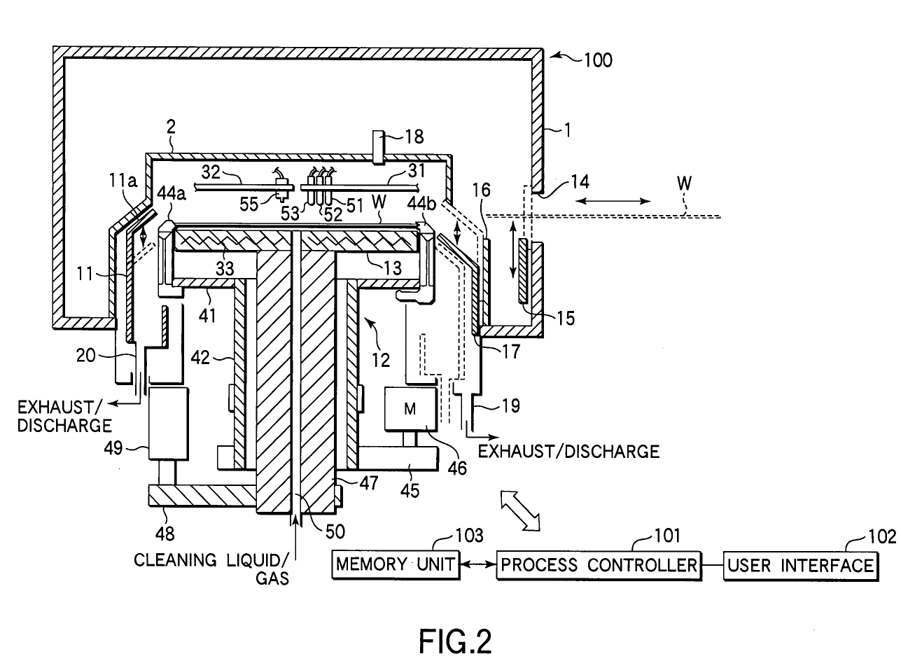

FIG. 1 is a top view schematically showing an exemplary wafer cleaning apparatus used for implementing a method according to the embodiment of the present invention, and FIG. 2 is a schematic cross section thereof. A wafer cleaning apparatus 100 has a housing 1, which includes an outer chamber 2 configured to house a wafer for cleaning, a first nozzle arm storage unit 3 configured to store a first nozzle arm 31, and a second nozzle arm storage unit 4 configured to store a second nozzle arm 32.

Furthermore, the wafer cleaning apparatus 100 includes an inner cup 11 (FIG. 2), a spin chuck 12, which holds a wafer W in the inner cup 11, and an under plate 13, which is provided capable of up and down movements and facing the back surface of the wafer W held by the spin chuck 12.

The housing 1 is formed with a window 14 used as an inlet and outlet for wafers, which is opened and closed by a first shutter 15. The window 14 is open at times of carrying the wafer W in or out, and is kept blocked by the first shutter 15 at other times. The first shutter 15 is made to open and close the window 14 from inside of the housing 1, and prevent atmosphere leakage from the housing 1 effectively even when the inside has a positive pressure.

A window 16 or wafer W inlet/outlet is positioned corresponding to the above-mentioned window 14 at the side of the outer chamber 2, and is opened and closed by a second shutter 17. The window 16 is open at times of carrying the wafer W in or out, and is kept blocked by the second shutter 17 at other times. The cleaning process for the wafer W is carried out within the outer chamber 2, where when carrying in/out the wafer W, both of the windows 14 and 16 are open, and a transfer arm, not shown in the drawing, is inserted into the outer chamber 2 from the outside to receive or hand over the wafer W to the spin chuck 12.

The second shutter 17 is also made to open and close the window 16 from inside of the outer chamber 2, and prevent atmosphere leakage from the outer chamber 2 effectively even when the inside has a positive pressure.

A gas inlet 18 for introducing an inert gas such as N₂ gas into the outer chamber 2 is provided on the upper wall of the outer chamber 2. This gas inlet 18 creates a down flow through the outer chamber 2 and prevents vapor of a chemical discharged to the wafer W held by the spin chuck 12 from filling the outer chamber 2. Creation of such down flow results in watermarks being difficult to generate on the front surface of the wafer W. A drain 19 is provided at the bottom of the outer chamber 2, allowing exhaust and drainage from the drain 19.

The inner cup 11 is used for preventing the chemical or purified water discharged to the wafer from scattering out to the surrounding area, and is provided surrounding the spin chuck 12 at the inner side of the outer chamber 2. This inner cup 11 has a tapered part 11a at the top and a drain 20 at the bottom. Furthermore, the inner cup 11 can be moved up and down between a processing position (indicated by a solid line in FIG. 2) at which the tapered part surrounds the wafer W and which the upper end of the inner cup is higher than the wafer W held by the spin chuck 12, and a retraction position (indicated by a dotted line in FIG. 2) at which the upper end of the inner cup is lower than the wafer W held by the spin chuck 12.

The inner cup 11 is maintained at the retraction position so as not to interrupt a transfer arm (not shown in the drawing) from entering/withdrawing at the time of carrying in/out the wafer W. Meanwhile, it is maintained at the processing position when cleaning the wafer W held by the spin chuck 12. In addition, the chemical used for cleaning the wafer W is lead to the drain 20. A chemical collecting line and an exhaust duct, not shown in the drawing, are connected to the drain 20, thereby preventing mist and the like generated within the inner cup 11 from scattering within the outer chamber 2.

The spin chuck 12 has a rotary plate 41 and a rotary tube 42 connected to the central region of the rotary plate 41 and extending therebelow, and a supporting pin 44a supporting the wafer W and a holding pin 44b holding the wafer W are attached to the rim of the rotary plate 41. Transfer of the wafer W between the transfer arm (not shown in the drawing) and the spin chuck 12 is carried out using this supporting pin 44a. The supporting pin 44a is preferably provided in at least three places in terms of securely supporting the wafer W. The holding pin 44b can be tilted so as for the upper tip of the holding pin 44b to move towards the outer side of the rotary plate 41. This is possible by a pressure mechanism, not shown in the drawing, pressing a portion of the holding pin 44b at a lower end of the rotary plate 41 against the rotary plate 41 so as not to prohibit transfer of the wafer W between the transfer arm (not shown in the drawing) and the spin chuck 12. The holding pin 44b is also preferably provided in at least three places in terms of securely holding the wafer W.

A belt 45 is wrapped around the lower end outer surface of the rotary tube 42, and thus driving the belt 45 with a motor 46 rotates the rotary tube 42 and the rotary plate 41, resulting in rotation of the wafer W held by the holding pin 44b.

The under plate 13 is connected to a shaft (supportive column) 47 inserted through the central region of the rotary plate 41 and the rotary tube 42. The lower end of the shaft 47 is fixed to a horizontal plate 48, and this horizontal plate 48 along with the lower end of the shaft 47 can be moved up and down by an elevating mechanism 49 such as an air cylinder. Then, the under plate 13 is lowered by this elevating mechanism 49 down to a position near the rotary plate 41 so as not to collide with the transfer arm when transferring the wafer W between the spin chuck 12 and the transfer arm (not shown in the drawing), and is raised to a position near the back surface of the wafer W when forming a puddle (liquid film) to clean the back surface of the wafer W. Furthermore, it is lowered to an appropriate position after the cleaning process using the puddle is completed. Note that the highest position of the under plate 13 is fixed, and the relative position of the wafer W held by the spin chuck 12 to the under plate 13 may be adjusted by raising and/or lowering the rotary tube 42.

A back surface cleaning nozzle 50 configured to supply a chemical or cleaning liquid, purified water or rinsing liquid, and a liquid film-breaking gas (e.g., nitrogen gas) onto the back surface of the wafer W is provided to the under plate 13 and the shaft 47 penetrating through the interior thereof. Furthermore, the under plate 13 has a heater 33 embedded therein, controlling the temperature of the wafer W via the under plate 13 by supplying power from a power source not shown in the drawing.

A window 21 is formed in a part of the first nozzle arm storage unit 3 adjacent to the outer chamber 2 and is opened and closed by a third shutter 22. The third shutter 22 is closed to separate the atmosphere in the first nozzle arm storage unit 3 from that in the outer chamber 2. A window 23 is formed in a part of the second nozzle arm storage unit 4 adjacent to the outer chamber 2 and is opened and closed by a fourth shutter 24. The fourth shutter 24 is closed when separating the atmosphere in the second nozzle arm storage unit 4 from that of the outer chamber 2.

The first nozzle arm 31, which is stored in the first nozzle arm storage unit 3, is capable of turning and moving up and down between the first nozzle arm storage unit 3 and the highest position of the wafer W center under the control of a driving mechanism 56 provided at an end of the first nozzle arm 31, and a liquid discharge nozzle 51 configured to discharge a chemical as a cleaning liquid and purified water as a rinsing liquid, a N₂ gas discharge nozzle 52 configured to discharge N₂ gas, and an IPA discharge nozzle 53 configured to discharge isopropyl alcohol (IPA) are provided at the front end thereof.

Meanwhile, the second nozzle arm 32, which is stored in the second nozzle arm storage unit 4, is capable of turning and moving up and down between the second nozzle arm storage unit 4 and the highest position of the wafer W center under the control of a driving mechanism 54 provided at an end of the second nozzle arm 32, and a two-fluid spray nozzle 55 for spraying N₂ gas and a mixture of purified water and IPA atomized by the N₂ gas is provided at the front end thereof.

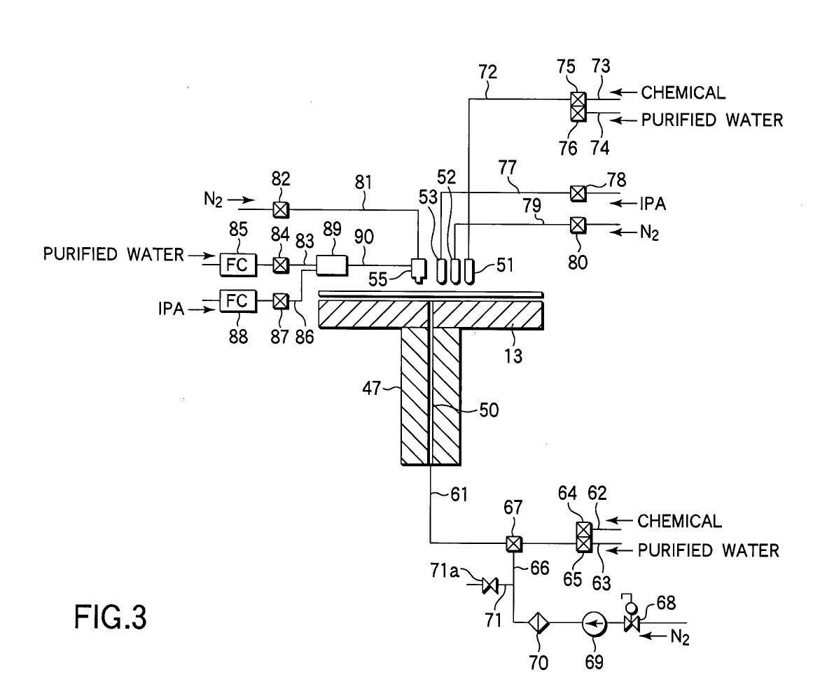

FIG. 3 is a diagram schematically showing a fluid supply system in the wafer cleaning apparatus 100. As shown in FIG. 3, a fluid supply line 61 is connected to the back surface cleaning nozzle 50. A chemical supply line 62 and a purified water supply line 63 are connected to the fluid supply line 61 via valves 64 and 65, respectively, allowing supply of a chemical as a cleaning liquid and purified water as a rinsing liquid to the back surface of the wafer W. Furthermore, a N₂ gas supply line 66 configured to supply N₂ gas via a valve 67 is connected along the fluid supply line 61. A regulator 68, a flow meter 69, and a filter 70 are provided to the N₂ gas supply line 66 in this order from the upper side, and an open line 71 for opening N₂ gas pressure to the outside is connected lower than the filter 70. A switching valve 71a is provided to the open line 71.

On the other hand, a liquid supply line 72 is connected to the liquid discharge nozzle 51 provided on the front surface side of the wafer. A chemical supply line 73 and a purified water supply line 74 are connected to the liquid supply line 72 via valves 75 and 76, respectively, allowing supply of a chemical as a cleaning liquid and purified water as a rinsing liquid to the front surface of the wafer W. An IPA supply line 77 is connected to the IPA discharge nozzle 53, and a valve 78 is provided to the line 77. A N₂ supply line 79 is connected to the N₂ gas discharge nozzle 52, and a valve 80 is provided to the line 79. Furthermore, a N₂ gas supply line 81 and a mixture supply line 90 are connected to the two-fluid spray nozzle 55, and a purified water supply line 83 and an IPA supply line 86 are connected to the mixture supply line 90 via a mixing valve 89. Moreover, a valve 84 and a flow controller 85 are provided to the purified water supply line 83, and a valve 87 and a flow controller 88 are provided to the IPA supply line 86. Flow of purified water from the purified water supply line 83 and flow of IPA from the IPA supply line 86 are controlled by the respective flow controllers 85 and 88, and then mixed at an arbitrary ratio under the control of the mixing valve 89. This mixture is then atomized in the two-fluid spray nozzle 55 by the N₂ gas supplied from the N₂ gas supply line 81, and the atomized mixture of purified water and IPA is sprayed out from the two-fluid spray nozzle 55 along with the N₂ gas. Note that flow controllers, not shown in the drawing, are also provided to lines other than the purified supply line 83 and the IPA supply line 86, adjustable to an arbitrary flow rate.

Each of components of the wafer cleaning apparatus 100 is connected to and controlled by a process controller 101 including a CPU. A user interface 102, which includes a keyboard used by a process manager to input commands for managing each of components of the wafer cleaning apparatus 100, a display configured to make visible and display operational statuses of the respective components of the wafer cleaning apparatus 100, and related units, and a memory unit 103, which is configured to store recipes including a control program and data specifying processing conditions for implementing various processes to be executed by the wafer cleaning apparatus 100 under control of the process controller 101, are connected to the process controller 101.

As needed, an instruction or the like is received from the user interface 102, an arbitrary recipe is read out from the memory unit 103 and then executed by the process controller 101, thereby allowing the cleaning apparatus 100 to execute various desired processes. A recipe may be stored in a readable storage media such as a CD-ROM, hard disk, flexible disk, nonvolatile memory, for example, or it may be transmitted as needed from an appropriate device via a dedicated circuit or the like and used online.

Next, the cleaning process for the wafer cleaning apparatus configured in the above manner is described. To begin with, the first shutter 15 provided to the housing 1 and the second shutter 17 provided to the outer chamber 2 are opened, the inner cup 11 is kept at the retraction position, the under plate 13 is kept waiting at a position near to the rotary plate 41, and the first nozzle arm 31 and the second nozzle arm 32 are stored in the first nozzle arm storage unit 3 and the second nozzle arm storage unit 4, respectively.

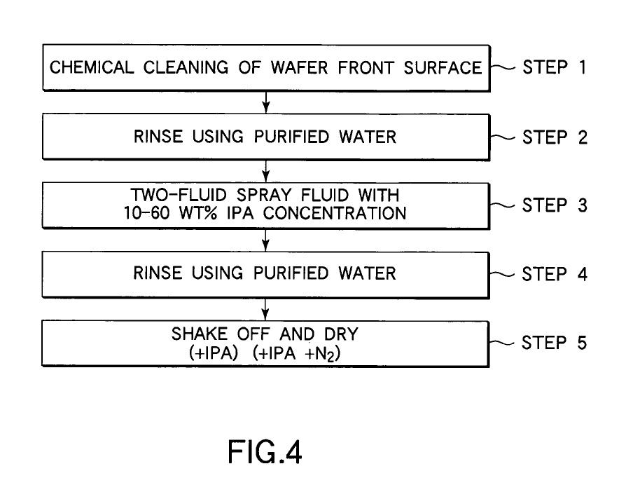

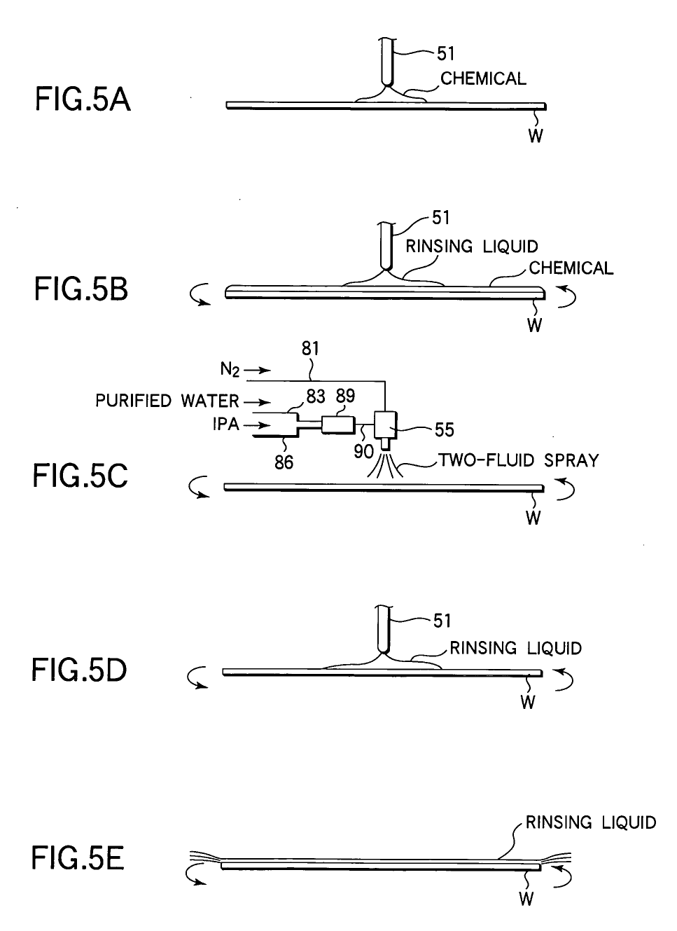

In this state, the wafer W is carried in to clean the front and back surfaces thereof simultaneously. Cleaning of the front surface of the wafer W is described first. FIG. 4 is a flowchart showing an exemplary procedure of the cleaning process for the wafer W front surface, and FIGS. 5A through 5E are schematics describing each of the steps in FIG. 4. To begin with, as shown in FIG. 5A, the liquid discharge nozzle arm 31 enters the outer chamber 2, the liquid discharge nozzle 51 is brought to a position above the center of the top surface of the wafer W, and a chemical is then supplied to the front surface of the wafer W via the chemical supply line 73, the liquid supply line 72, and the liquid discharge nozzle 51 to carry out the cleaning process (Step 1). The cleaning process using this chemical is primarily carried out to remove minute particles adhered to the front surface of the wafer W. At this time, proceeding of the cleaning process may be expedited by supplying a predetermined amount of the chemical onto the front surface of the wafer W and form a puddle (liquid film), or cleaning may be carried out while the chemical flows thereover. The wafer W may also be rotated at approximately 10 to 1000 rpm from rest.

Next, as shown in FIG. 5B, the chemical supply line 73 is switched over to the purified water supply line 74, purified water is supplied as a rinsing liquid from the liquid discharge nozzle 51, and the rinsing process is carried out (Step 2). This rinses away the chemical from the front surface of the wafer W. The wafer rotational speed at this time is approximately 500 to 1500 rpm. Note that this rinsing step is not mandatory.

Afterwards, as shown in FIG. 5C, the first nozzle arm 31 is stored in the first nozzle arm storage unit 3, the second nozzle arm 32 enters the outer chamber 2, the two-fluid spray nozzle 55 is brought to a position above the center of the wafer W, and a two-fluid spray of N₂ gas and a mixture made up of purified water and IPA with an IPA concentration of 10 to 60 wt % is supplied to the front surface of the wafer W from the two-fluid spray nozzle 55 (Step 3). The wafer rotational speed at this time is preferably approximately 500 to 2000 rpm.

Use of a mixture made up of purified water and IPA as the liquid for forming two-fluid spray as described above allows higher rejection of particles than when using only the conventionally used purified water. Making a mixture including 10 to 60 wt % of IPA in this manner allows a particle rejection ratio of 80% or greater with little spray impact, namely little damage to the wafer. 30 to 40 wt % of IPA is further preferable. This allows a particle rejection ratio of 85% or greater with little damage to the wafer.

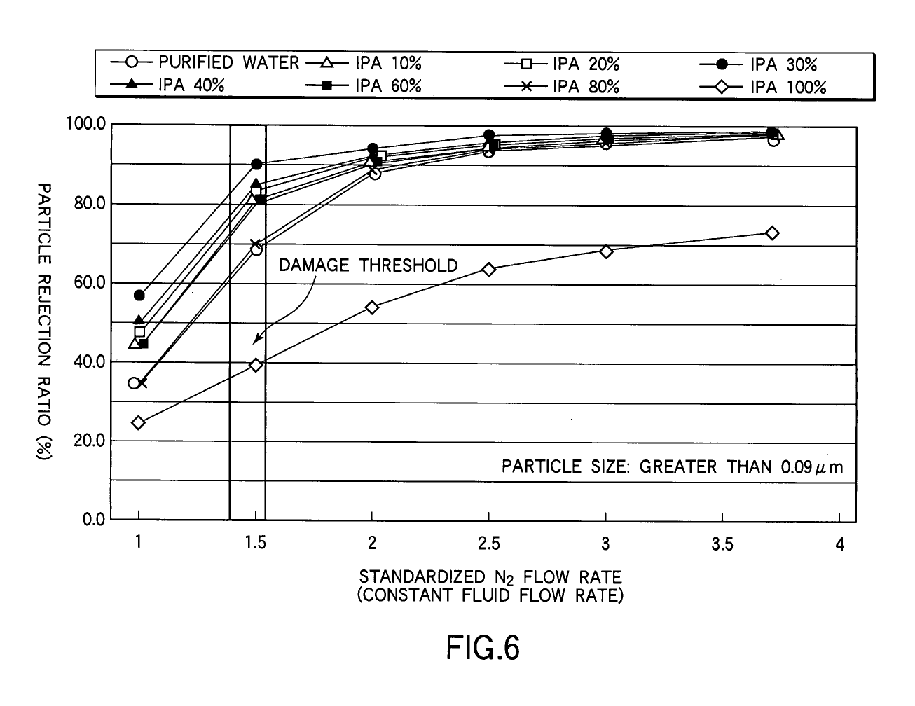

This is described forthwith while referencing FIG. 6. FIG. 6 is a graph showing a relationship between N₂ gas flow rate and particle rejection ratio when changing the IPA concentration of a mixture used for a two-fluid spray; where the lateral axis represents standardized N₂ gas flow rate (constant liquid flow rate) in the two-fluid spray nozzle while the longitudinal axis represents particle rejection ratio. This shows cases using a wafer with actual patterns formed thereupon, having particles of 0.09 μm or greater. Note that particles are measured using a SURESCAN SPIDLS. Also note that a ‘damage threshold’ region shown in the drawing means that damage to the wafer exceeds a permissible limit when the N₂ gas flow rate is increased more than that in the region.

As is evident from FIG. 6, in the case of 100% purified water, N₂ gas flow rate must be increased when trying to achieve a particle rejection ratio of 80% or greater, thereby exceeding the ‘damage threshold’ and damage to the wafer not remaining within the permissible limit. On the other hand, when it does not exceed the ‘damage threshold’, namely damage to the wafer is within the permissible limit, particle rejection ratio is insufficient. Meanwhile, inclusion of 10 wt % of IPA abruptly increases the particle rejection ratio and a high particle rejection ratio may be achieved even with a lower N₂ flow rate, thereby achieving a rejection ratio of 80% or greater with a N₂ gas flow rate less than the ‘damage threshold’ without much damage to the pattern. While the pattern rejection ratio maximizes with 30 wt % IPA and decreases as the value in wt % increases, a rejection ratio of 80% or more is achievable with a N₂ gas flow rate less than the ‘damage threshold’ without hardly any damage to the pattern even with 60 wt % IPA. When exceeding 60 wt % of IPA, a particle rejection ratio of 80% or more is impossible to achieve with a N₂ gas flow rate less than the ‘damage threshold’; however, with 100% IPA, it is understood that the rejection ratio reaches only close to 75% even if the N₂ gas flow rate is radically increased.

This allows minimization of pattern damage and a particle rejection ratio of 80% or greater with an IPA concentration of the purified water and IPA mixture in the two-fluid spray between 10 and 60 wt %. Furthermore, a mixture flow rate of at least 200 mL/min is preferable in respect of effective rejection of particles.

After such two-fluid spraying, as shown in FIG. 5D, the second nozzle arm 32 is stored in the second nozzle arm storage unit 4, the first nozzle arm 31 enters the outer chamber 2, the liquid discharge nozzle 51 is brought to a position above the center of the front surface of the wafer W, and purified water is then supplied to the front surface of the wafer W via the purified water supply line 74, the liquid supply line 72, and the liquid discharge nozzle 51 to carry out the rinsing process (Step 4).

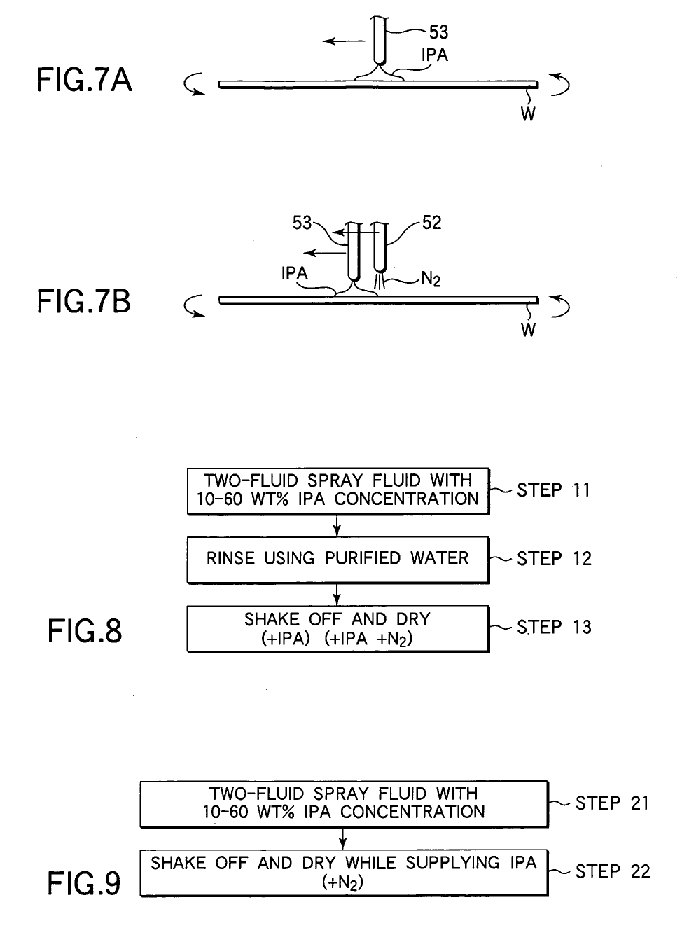

After the rinsing process, the wafer W is rotated at a high speed of 300 rpm or greater, for example, 1000 rpm, to shake off and dry, as shown in FIG. 5E (Step 5). At this time, if the wafer W front surface is hydrophobic, it is preferable to bring the IPA discharge nozzle 53 to a position above the center of the wafer W front surface, scan therefrom outward, and supply thereupon almost 100% concentration of IPA via the IPA supply line 77 and the IPA discharge nozzle 53, as shown in FIG. 7A. This promotes drying and inhibits generation of watermarks. Furthermore, as shown in FIG. 7B, it is preferable to discharge N₂ gas from the N₂ gas discharge nozzle 52 via the N₂ gas supply line 79 at the same time as supplying the IPA. As a result, the IPA discharged from the IPA discharge nozzle 53 is followed by N₂ gas, remaining particles on the wafer W can be effectively removed and then quickly dried, and generation of watermarks can be almost totally prevented.

Next, back surface cleaning is described.

First, the gap between the wafer W and the under plate 13 is set to 4 mm or greater, for example, 10 mm or greater so the under plate 13 does not interrupt the wafer from entering. The under plate 13 is then raised to a position near the back surface of the wafer W held by the spin chuck 12, setting the gap between the wafer W and the under plate 13 between 0.5 and 3 mm, for example, 0.8 mm.

Next, during the above-given Step 1, a predetermined chemical is supplied as a cleaning liquid in the gap between the wafer W and the under plate 13 via the chemical supply line 62, the fluid supply line 61, and the back surface cleaning nozzle 50, and the cleaning process is then carried out.

Once the cleaning process using the chemical is finished, purified water is supplied as a rinsing liquid between the wafer W back surface and the under plate 13 via the purified water supply line 63, the fluid supply line 61, and the back surface cleaning nozzle 50.

The under plate is lowered, but in order to prevent a vacuum from occurring between the wafer W and the under plate 13 and the wafer W from bending or breaking, it is preferable to first supply N₂ gas therebetween via the N₂ gas line 66, the fluid supply line 61, and the back surface cleaning nozzle 50 to destroy the liquid film formed therebetween. Note that although gas pressure in the N₂ gas line 66 at this time may be high, and an inconvenience such that N₂ gas is suddenly supplied between the wafer W and the under plate 13 when the valve 67 remains open and the wafer W is thus pushed up may occur. This may be resolved by leaving open the switching valve 71a for the open line 71 in advance to release the pressure from within the N₂ gas supply line 66.

The gap between the wafer W and the under plate 13 is widened by lowering the under plate 13, purified water is supplied therebetween as a rinsing liquid via the purified water supply line 63, the fluid supply line 61, and the back surface cleaning nozzle 50, and a rinsing process is then carried out. While the series of steps carried out up to this rinsing process corresponds to the rinsing step of Step 2, the two-fluid spray cleaning of the wafer W front surface of Step 3, and the rinsing process of the wafer W front surface of Step 4, purified water is supplied onto the back surface of the wafer W when two-fluid spraying the wafer W front surface.

Afterwards, purified water supply is stopped, the under plate 13 is further lowered, the gap between the wafer W and the under plate 13 is set to 4 mm or greater, for example, 10 mm, and the wafer W is rotated at 300 rpm or greater, for example, 1000 rpm as described above in the above-given Step 5 to shake off and dry. At this time, N₂ gas may be supplied to promote drying.

Once cleaning the front and back surfaces of the wafer W in this manner is completed, the transfer arm, not shown in the drawing, is inserted below the wafer W while the gap between the wafer W and the under plate 13 is maintained at 4 mm or greater, for example, 10 mm, to hand over the wafer W to the transfer arm.

With the above embodiment, a chemical process, a rinsing process, a two-fluid spraying process using a mixture of purified water and IPA as the liquid, a rinsing process, and a drying process are successively carried out in the cleaning process for the wafer W front surface; however, as shown in FIG. 8, without carrying out the chemical process and the subsequent rinsing process, a method where the two-fluid spraying process as in Step 3 is first carried out using a mixture of purified water and IPA as a liquid (Step 11), the same rinsing process as in Step 4 is carried out (Step 12), and the same drying process as in Step 5 is then carried out (Step 13) may be used. Such processes are employed when there are only relatively large particles and thus the chemical process is not necessary, and when there is an area of the front surface of the wafer W reacting to the chemical and thus cleaning using a chemical is impossible.

Furthermore, as shown in FIG. 9, a method where the same two-fluid spraying process as in Step 3 is first carried out using a mixture of purified water and IPA as a liquid (Step 21), and without the rinsing process, the same drying process supplying IPA as in Step 5 is then carried out (Step 22) may be used. Such a method has an advantage of improving throughput. However, since this method must be executed while supplying IPA to the wafer in Step 22 and utilizing the rinsing effect at that time, it is favorably used for a wafer W with a hydrophobic front surface. Moreover, it is favorable to supply N₂ simultaneous to the IPA.

In the case of carrying out the wafer W front surface cleaning process of FIGS. 8 and 9, back surface cleaning of the wafer W is required accordingly in conformity with these steps.

Note that the present invention is not limited to the above-given embodiment, and various modifications are possible within the scope of the present invention. For example, with the above-given embodiment, an example where the present invention is applied to front surface cleaning when cleaning the front surface and the back surface of a wafer as a to-be-processed substrate simultaneously has been described; however, it may be applied to the case of only implementing front surface cleaning.

Furthermore, while the case of using a semiconductor wafer as a to-be-processed substrate has been given with the above-given embodiment, needless to say another substrate such as a substrate for a flat panel display (FPD) represented by a glass substrate for a liquid crystal display (LCD) is applicable.

What is claimed is:

1. A substrate cleaning method comprising:
preparing a substrate; and
supplying a two-fluid spray made up of a liquid and a gas to the front surface of the substrate, wherein:
the supplying of the two-fluid spray is carried out using a mixture of purified water and isopropyl alcohol as a liquid; concentration of the isopropyl alcohol in the mixture is 10 to 60 wt %; and a particle rejection ratio is 80% or greater.

2. The method of claim 1, further comprising rotating the substrate and shaking off and drying liquid remaining on the substrate.

3. The method of claim 2, wherein the shaking off and drying liquid is performed while supplying nearly 100% concentration of isopropyl alcohol.

4. The method of claim 2, wherein the shaking off and drying liquid is performed while supplying nearly 100% concentration of isopropyl alcohol and nitrogen gas.

5. The method of claim 1, wherein concentration of the isopropyl alcohol in the mixture is 30 to 40 wt %, and the particle rejection ratio is 85% or greater.

6. The method of claim 1, wherein flow rate of the mixture is 200 mL/min or greater.

7. A substrate cleaning method, comprising:
preparing a substrate;
supplying a chemical to the front surface of the substrate;
supplying a two-fluid spray made up of a liquid and a gas to the front surface of the substrate after the chemical is supplied; and
supplying a rinsing liquid to the substrate after the two-fluid spray is supplied, wherein:
the supplying of the two-fluid spray is carried out using a mixture of purified water and isopropyl alcohol as a liquid; an concentration of the isopropyl alcohol in the mixture is 10 to 60 wt %; and a particle rejection ratio is 80% or greater.

8. The method of claim 7, further comprising rotating the substrate and shaking off and drying liquid remaining on the substrate.

9. The method of claim 8, wherein the shaking off and drying liquid is performed while supplying nearly 100% concentration of isopropyl alcohol.

10. The method of claim 8, wherein the shaking off and drying liquid is performed while supplying nearly 100% concentration of isopropyl alcohol and nitrogen gas.

11. The method of claim 7, wherein concentration of the isopropyl alcohol in the mixture is 30 to 40 wt %, and the particle rejection ratio is 85% or greater.

12. The method of claim 7, wherein flow rate of the mixture is 200 mL/min or greater.

13. A substrate cleaning method, comprising:
preparing a substrate;
supplying a two-fluid spray made up of a liquid and a gas to the front surface of the substrate; and
supplying a rinsing liquid to the substrate after the two-fluid spray is supplied, wherein:
the supplying of the two-fluid spray is carried out using a mixture of purified water and isopropyl alcohol as a liquid; concentration of the isopropyl alcohol in the mixture is 10 to 60 wt %; and a particle rejection ratio is 80% or greater.

14. The method of claim 13, further comprising rotating the substrate and shaking off and drying liquid remaining on the substrate.

15. The method of claim 14, wherein the shaking off and drying liquid is performed while supplying nearly 100% concentration of isopropyl alcohol.

16. The method of claim 14, wherein the shaking off and drying liquid is performed while supplying nearly 100% concentration of isopropyl alcohol and nitrogen gas.

17. The method of claim 13, wherein the concentration of the isopropyl alcohol in the mixture is 30 to 40 wt %, and the particle rejection ratio is 85% or greater.

18. The method of claim 13, wherein flow rate of the mixture is 200 mL/min or greater.

19. A substrate cleaning apparatus configured to clean the front surface of a substrate, comprising:
a substrate holding unit, which holds the substrate horizontally;
a two-fluid spray nozzle, which supplies a two-fluid spray made up of a gas and a mixture of purified water and isopropyl alcohol to the front surface of the substrate; and
a control mechanism, which controls amounts of purified water, isopropyl alcohol, and the gas to be supplied from the two-fluid spray nozzle such that the isopropyl alcohol concentration within the mixture can be 10 to 60 wt % and that a particle rejection ratio for the substrate by the two-fluid spray can be 80% or greater.

20. A computer readable storage media in which a control program to be executed by a computer is stored, wherein:
the control program represents a substrate cleaning method comprising preparing a substrate and supplying a two-fluid spray made up of a liquid and a gas to the front surface of the substrate, which are executed in conformity with the control program, and the control program causes the computer to control a liquid processing apparatus implementing the substrate cleaning method such that the supplying of the two-fluid spray uses as a liquid a mixture of purified water and isopropyl alcohol, which has a concentration of 10 to 60 wt % within the mixture and a particle rejection ratio of 80% or greater.
